(19) United States
(12) Patent Application Publication
(10) Pub. No.: US 2016/0207816 A1
(43) Pub. Date: Jul. 21, 2016

(54) GRAINED SURFACE PROFILE MODEL

(71) Applicant: SMP DEUTSCHLAND GMBH, Boetzingen (DE)

(72) Inventor: Yann Buchet, Strasbourg (FR)

(21) Appl. No.: 14/996,747

(22) Filed: Jan. 15, 2016

(30) Foreign Application Priority Data
Jan. 20, 2015 (EP) 15151796.8

(51) Int. Cl. C03B 11/08; C01B 33/02

(52) U.S. Cl. CPC C03B 11/08; C01B 33/02

(57) ABSTRACT

A grained surface model is proposed that includes a milling model with a groove having a groove bottom, a skin disposed at the milling model as well as a first cut and a second cut connected by a joint line forming a first positioning section and a second positioning section, wherein the first positioning section extends between the joint line and a front end of the first cut and the second positioning section extends between the joint line and a front end of the second cut and wherein the front ends of each of the two positioning sections are inserted into the groove indirection of the groove bottom and wherein the joint line is sealed.

### CROSS-REFERENCES TO RELATED APPLICATIONS

This application claims the priority of European Patent Application Serial No. EP 15 151 796.8, filed Jan. 20, 2015, pursuant to 35 U.S.C. 119(a)-(d), the subject matter of which is incorporated herein by reference.

### BACKGROUND OF THE INVENTION

The present invention relates to a defined surface profile model, in particular a textured surface model including a grained surface model that includes a milling model for molded skins utilized in particular for interior paneling, instrument panel and similar in motor vehicles.

For the purpose of producing such defined surface profiles, a silicone impression is made from the defined surface profile model from which a galvanic form is produced. By means of a molding process, for example, a slush-, spray- or deep drawing process, a molded skin is produced from the galvanic form.

From DE 101 02 600 B4 a process for producing molded skins for vehicle interior paneling is known. The reference discloses a grained surface model form which serves the production of a visible, grained side of a silicone negative. A grained skin is applied to the grained surface model without producing a seam.

To give the impression of natural leather, oftentimes the molded skins applied to a grained surface model are produced from cut pieces that are connected by a sewn seam.

Such grained surface models have the drawback that when casting a silicone impression, silicon can seep through the seam at certain leakage points on the seam. Thus, when the silicone leaks out, no clean demolding of the silicone impression having a defined profile, can be realized.

According to the conventional methods, to prevent the silicone leakage, possible leakage points are sealed with a filler compound. However, application of filler compound of course ruins the impression that the seam is authentic.

Furthermore, with sewn seams the drawback exists in that the puncture sites from the needle provides additional areas for silicone to leak through.

It would therefore be desirable and advantageous to provide an improved grained surface model to obviate prior art shortcomings, in particular when producing silicone impressions which can provide a clean and natural looking grained surface.

### SUMMARY OF THE INVENTION

As used herein, the terms “grain” or “grained” refer broadly and generically to various types of surface treatments which include small scale random, irregular, semi-irregular or regular surface finishes having aesthetic significance and which mimics, for example, leather, wood or other natural or manmade surfaces, surface treatments or finishes.

According to one aspect of the present invention, the grained surface model includes a milling model having at least one groove with a groove bottom, wherein a molded skin applied to the milling model consists of at least a first cut and a second cut, wherein the first cut and the second cut are connected via at least one joint line under formation of a first positioning section and a second positioning section, wherein the first positioning section is arranged between the joint line and a front end of the first cut and the second positioning section is arranged between the joint line and a front end of the second positioning section, wherein each of the front end of the first and second positioning sections are inserted into the groove in direction of the groove bottom such that the joint line is then sealed.

Advantageous features of the various embodiments are subject of the dependent claims.

The grained surface model of the present invention is essentially a milling model with a molded skin applied thereto. The milling model includes at least one groove with a groove bottom while the skin is composed of two cuts, a first cut and a second cut. The two cuts are joined via a joint line creating two positioning sections. The first positioning section extends between the joint line and a front end of the first cut and the second positioning section extends between the joint line and a front end of the second cut. Each of the front ends of the positioning sections are inserted into the groove with the front end of each of the sections facing the groove bottom and in this manner positioning the molded skin.

In another aspect of the present invention at least the joint line is configured leak proof and the opposing positioning sections thereby connected to each other. In this manner, in the area directly at the joint line the positioning sections are joined in a sealed manner so that no silicon from the silicone impression could penetrate the joint line between the two positioning sections. Thus, during production of the molded skin, the joint line will be shown on the silicone negative with a defined profile.

The skin of the grained surface model is preferably a film skin or an imitation leather skin. Skins of this type can be produced and grained easily and in a cost effective manner so that they look like real or natural leather.

In a variant embodiment of the present invention, the joint line is a welded seam or a glued seam. In this manner, the cuts can be closely joined while at the same time a cost-effective high quality product can be realized.

Advantageously, the positioning sections are substantially completely welded or glued to each other while forming a joint surface. Thus, even below the joint line, the positioning sections are sealingly joined.

In a further embodiment of the present invention, the joint line is a textile seam. A textile seam represents a further alternative of a seam. When producing the textile seam, the usually known yarns or threads are utilized, and the textile seam advantageously enhances the impression of a real leather look.

According a preferred variant of the present invention, the positioning sections for creating the joint line are connected by sewing with a thread. The positioning sections can also be sealingly connected with each other below the joint line, by additional seams.

According to a further feature of the present invention, at least one sealing element is inserted between the positioning sections, so that the positioning sections in direction toward the groove bottom are sealingly covered. The sealing element can thereby encompass the positioning sections. The sealing element inserted between the positioning sections can extend up to the joint line. The sealing element can also seal a gap which possibly occurs in the area below the joint line between the positioning sections, to prevent a possible leakage of silicone.

Advantageously, the sealing element encompassing the positioning sections projects out of the groove, so that the positioning sections inserted in the groove are not in contact with groove flanks.

In accordance with another feature of the present invention, the sealing element is a band, preferably a textile band. Such a sealing element is especially simple to produce and to utilize.

In a further variant embodiment of the present invention, the band is sewn together with the first cut and the second cut. In this manner, the cuts can be joined together in a single production step and a gap between the joined positioning sections covered, leading to a reinforcement of the seam.

According to a preferred embodiment of the present invention, the band is glued on or welded on. Gluing or welding represents a practical alternative to sewing. Preferably, the band also covers the threaded puncture points to reduce leakage of silicone at the threaded puncture points.

As a further feature of the present invention the band exhibits at least a first bump or thickening. Such a bump is also disclosed in DE 10 2012 100 891 A1. Such a bump can penetrate into a gap between the positioning sections when the band is fastened at the positioning sections for sealing the gap.

Advantageously, the band exhibits a crease perforation in the area of the first bump. Such a crease perforation enables easier forming and easier processing of the band.

Preferably, the band has a second bump located opposite the first bump. With the second bump, the positioning sections can be positioned especially secure and precise within the groove.

In an alternative embodiment of the present invention, the sealing element is an insert which can be present in the form of an extrusion profile, preferably an elastic extrusion profile, a clip-on element, an injection-molded part, an adhesive tape activated by heat or a combination of these. Such an insert produces an especially good seal for the seam.

Advantageously, at least one reinforcement element, preferably a clip-on element, a sewing thread, an adhesive layer or a combination of the afore-stated elements are attached at the positioning sections, wherein the reinforcement element additionally improves the cohesion of the positioning sections inserted in the groove. In addition to the sealing function, the cohesion of the joined surfaces can be optimized so that the joint surfaces and joint line function in a secure manner. These types of reinforcement elements can also be utilized in addition to the sealing element.

Preferably, the positioning sections are coordinated to a depth of the groove by an edge trim, so that the joint line can be adjusted to the dimension of the groove in an exact and simple manner.

In an advantageous embodiment of the present invention, the milling model is a multi-part milling model, wherein a separation line of adjoining single parts extends through the at least one groove. Usually multi-part milling models are pressed together after insertion of the skin. Such pressure improves the sealing of possible points of leakage of material.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a side view of an embodiment of a grained surface model according to the present invention;

FIG. 2 is a detail illustration of an embodiment of a groove of a grained surface model according to FIG. 1 with an embodiment of a sewn to sealing element;

FIG. 2a is an embodiment of a band and an embodiment of a bump;

FIG. 2b is an embodiment of two cuts of a skin of a grained surface model according to FIG. 1 with a band having a bump according to FIG. 2a just prior to the band being sewn to the cuts;

FIG. 2c shows two cuts according to FIG. 2b with a band and a bump according to FIG. 2a after the band is sewn to the cuts;

FIG. 2d shows a molded skin inserted into the groove after sewing according to FIG. 2c;

FIG. 3 is a detail representation of an embodiment of a groove of a grained surface model according to FIG. 1 showing an embodiment of a reinforcement element;

FIG. 4a is a side view of an embodiment of a two-part grained surface model prior to assembly;

FIG. 4b is a grained surface model according to FIG. 4a at a reduced gap width;

FIG. 5a is an embodiment of a band and a further embodiment of a bump;

FIG. 5b is an embodiment of a band with a perforation and a bump according to FIG. 5a;

FIG. 5c is a band according to FIG. 5a with a further embodiment of a bump;

FIG. 5d is a band according to FIG. 2a with an embodiment of a second bump;

FIG. 5e is a band according to FIG. 5d with an additional embodiment of a second bump;

FIG. 6a is an embodiment of joined positioning sections in an initial state;

FIG. 6b is an embodiment of positioning sections according to FIG. 6a after sewing and edge trim;

FIG. 6c shows positioning sections according to FIG. 6b inserted into the groove according to FIG. 2;

FIG. 7a shows positioning sections according to FIG. 6b without sewing together, and

FIG. 7b shows positioning sections according to FIG. 7a inserted into the groove according to FIG. 2.

### DETAILED DESCRIPTION OF PREFERRED EMBODIMENTS

Throughout all the Figures, same or corresponding elements are generally indicated by same reference numerals.

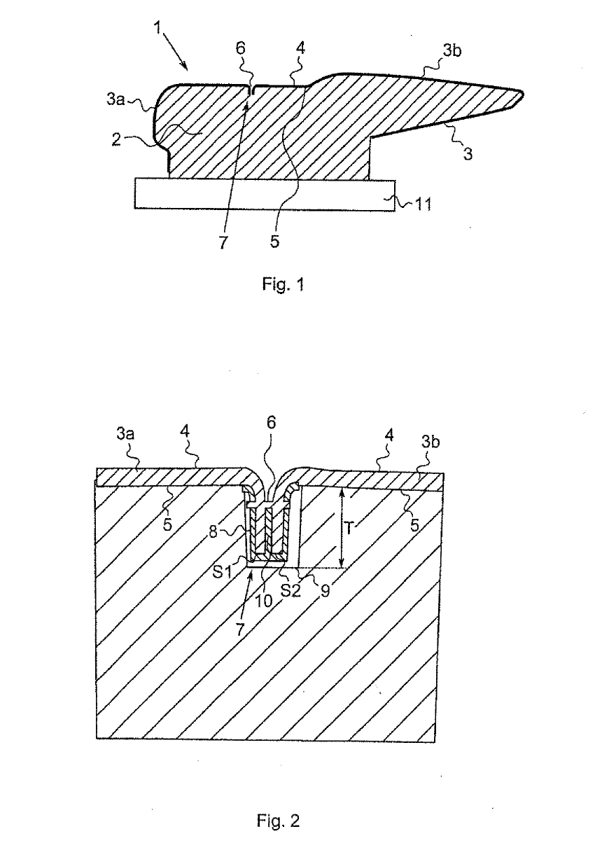

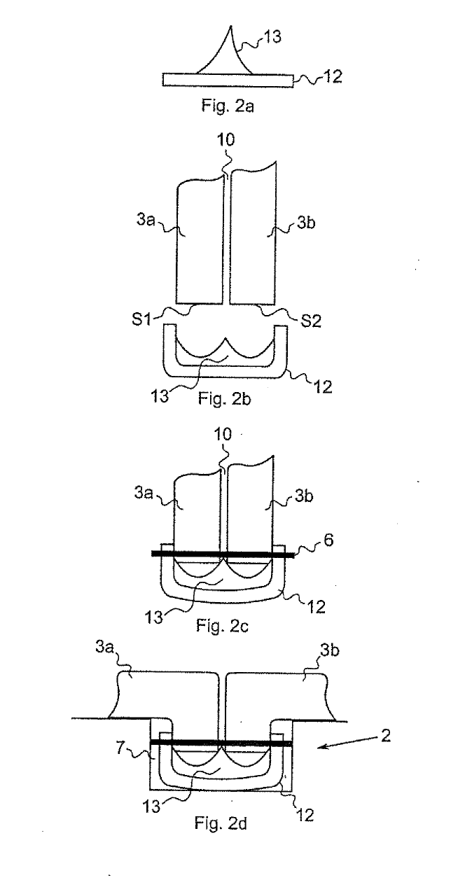

Turning now to the drawing, and in particular to FIG. 1, there is shown a grained surface profile model l with a milling model 2 and support 11, wherein a molded skin 3 is applied to the milling model. The milling model 2 has a groove 7 with a groove bottom 9, see also FIG. 2.

The contour of milling model 2 represents the shape of an interior panel component, for example in the shape of a door paneling or an interior door area, for example an arm rest or railing.

The molded skin 3 can show the grain of natural leather in a realistic manner so that a structured side 4 of the skin 3 and thus the surface of the silicone impression gives the impression of real leather. The skin 3 is placed with the reverse side opposite the structured side 4 on the milling model 2 at least outside of groove 7, and suitably fixated.

As shown, the skin 3 consists of a first cut 3a and a second cut 3b connected via at least one joint line L, as also shown in FIG. 2. The first cut 3a has a positioning section A1 extending between the joint line L and a front end S1 of the first cut 3a. The second cut 3b shows positioning sections A2 extending between the joint line L and a front end S2 and the second cut 3b. A length of positioning section A1 and a length of positioning sections A2 are dimensioned for insertion of each of the front ends S1, S2 of positioning section A1, A2 into the groove 7 in direction toward the groove bottom 9.

The two cuts 3a and 3b are connected under formation of joint line L, as for example shown in FIGS. 2, 3, 6c, 7b.

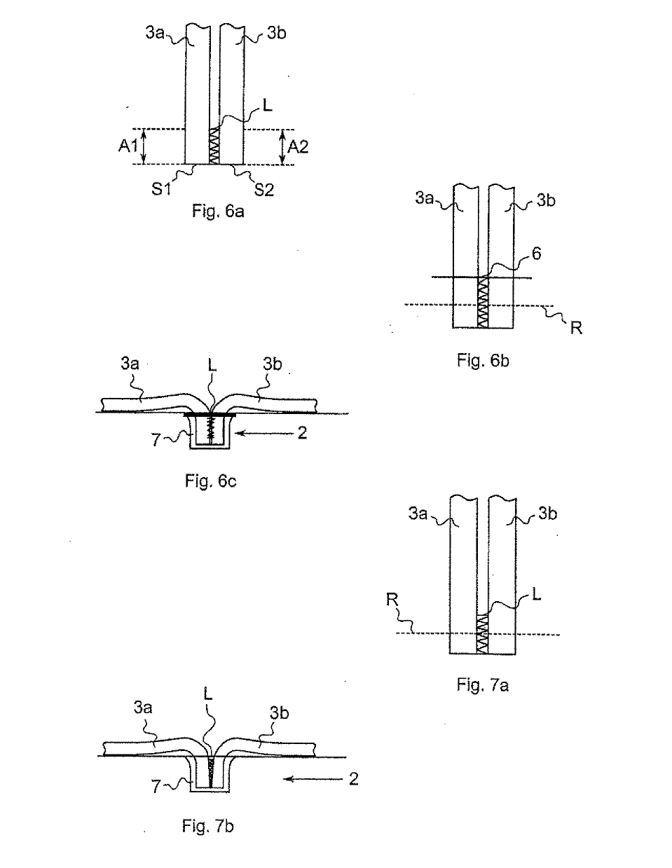

FIG. 2 shows cuts 3a and 3b that are joined according to a textile joining process. For example, cuts 3a and 3b are sewn together with thread 6. Thread 6, or any seam resulting from sewing is an example for a joint line L, as for example shown in FIG. 6a. The joint line L is a visible border of joint surfaces F where the positioning sections A1, A2 facing each other are connected. The structured side 4 below the joint line L is not visible.

Between the positioning sections A1, A2 inserted into the groove 7, a gap 10 may be present, when the cuts 3a, 3b are sewn to each other, as shown in FIG. 2.

FIG. 2 shows a sealing element 8, which covers the gap 10 in a sealing manner. The sealing element 8 is for example sewn together with cuts 3a and 3b. In FIG. 2, the sealing element 8 sealingly covers the reverse sides 5 of positioning sections A1, A2, wherein thread 6 pierces the sealing element.

Alternatively, the sealing element 8 can also be glued, clipped to or otherwise disposed at the reverse sides 5 of positioning sections A1, A2. The sealing element can also have the shape of a band 12 or be provided in the form of an insert.

FIGS. 2a to 2c illustrate how the sealing element 8 in the form of a band 12 are joined with cuts 3a and 3b. FIG. 2d shows how band 12 with cuts 3a and 3b are inserted into the groove 7.

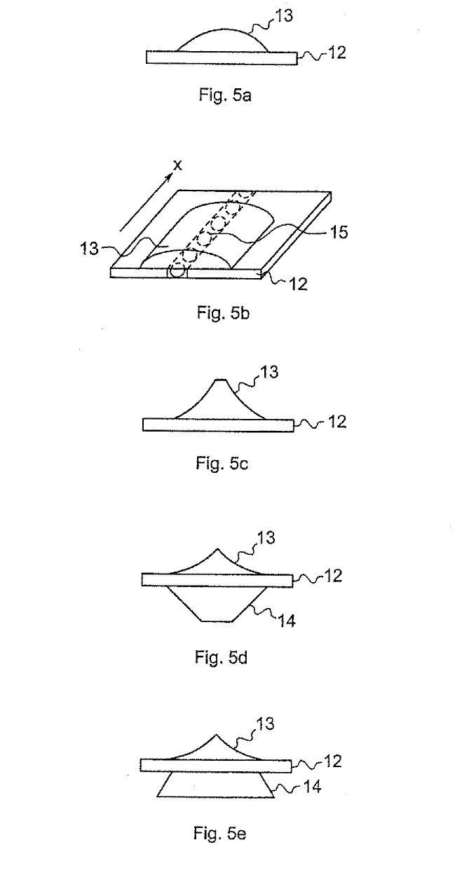

FIG. 2a is a side view of a band 12 having at least a first bump 13 in an initial state. The first bump 13 according to FIG. 2a has a lateral surface that is essentially triangle shaped. Other shapes the bump 13 can have are also possible. For example, FIG. 5a shows a first bump 13 having a semicircular lateral surface. FIG. 5c shows the example of a first bump 13 with a trapezoidal lateral surface. The first bump 13 is fastened to the band either by sewing, gluing, welding or in any other manner. The first bump 13 can be also be made from a deformable material.

Band 12 with its first bump 13 can be formed into a U-shape, so that the legs of the U clasp the reverse sides 5 of the positioning sections A1, A2, wherein the first bump 13 penetrates the gap 10 between the visible structured sides 4 facing each other in order to seal the gap 10; compare also FIGS. 2b, 2c. Thereby, band 12 can be in the shape of a lip.

To provide a band 12 that can be easily formed and thus easily processed when producing, for example, a U shape, the band 12 is provided centrical, relative to a length direction x in the area of the first bump 13, with a creased perforation 15 as shown in FIG. 5.

FIG. 2b shows the positioning sections A1, A2 with band 12 and the first bump 13 just prior to sewing. FIG. 2c shows the band 12 which was sewn together with cuts 3a and 3b. The first bump is thereby inserted into the gap 10.

For better positioning band 12 in groove 7, band 12 includes at least a second bump which is disposed lateral of band 12, opposite the first bump. Analog to the first bump 13, the second bump 14 can be affixed to band 12. The shape of the second bump 14 can be optimally adjusted to the shape of the groove 7 receiving the second bump.

FIG. 5d shows a side view of band 12 with a first bump 13 and a second bump 14. The second bump 14 has, for example, the lateral surface of a trapeze. FIG. 5e shows the side view of a band 12 with a first bump 13 and a second bump 14, wherein the bump 14 has a shape different from that in FIG. 5d.

By joining the positioning sections, the structured sides 4 in the joined areas of the positioning sections A1, A2 are facing each other and seal the juncture. A sealing function even with the structured sides 4 sewn together can also be realized by the use of a band 12. In particular, a band 12 can seal the puncture points of thread 6.

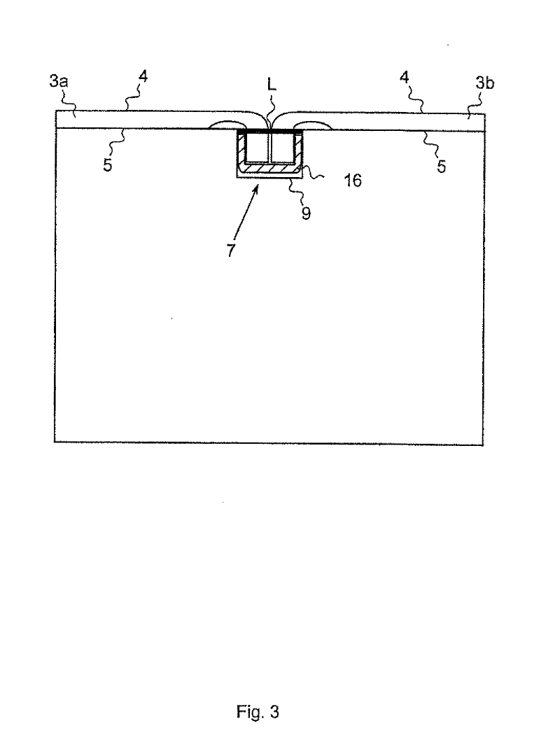

Besides the sealing function according to the present invention a reinforcement function can also be provided. For example, FIG. 3 shows a reinforcement element 16, which after joining the cuts 3a and 3b is glued to the reverse sides 5 and cover, for example, the front ends S1, S2. Also, the reinforcement element 16 can be a sewing thread.

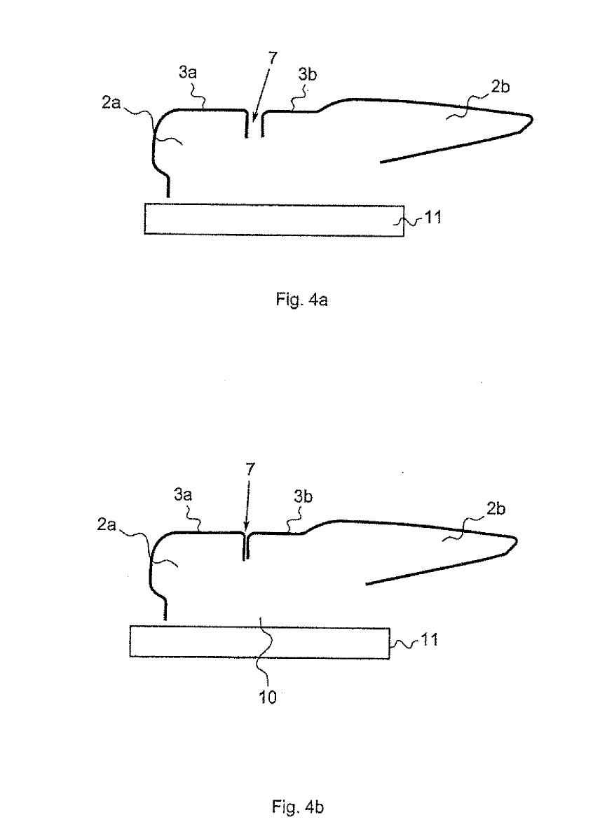

FIG. 4a depicts a milling model 2 consisting of a first component 2a and a second component 2b and disposed on a base support 11. Skins 3 are applied to each of components 2a and 2b. Components 2a and 2b are still distanced from each other showing a gap 10. FIG. 4b shows the components 2a and 2b of the multi-part milling model 2 of FIG. 4a, where the gap is shown narrowed as compared to FIG. 4a, so the two components 2a and 2b can be pressed against each other.

FIGS. 6a, 6b, 6c show the steps in the process where the cuts 3a and 3b are inserted into the groove 7 of milling model 2. FIG. 6a shows a first step, where the positioning sections A1, A2 are sealingly joined by either gluing or welding, while a corresponding joint line L is created in the form of a glued seam or a welded seam. The thus joined positioning sections A1, A2, in a second step, are also reinforced in their juncture by means of a thread 6 serving as a reinforcement element 16. Optionally, an edge trim R can be applied as shown in FIG. 6b. The edge trim R permits an adjustment of the positioning sections A1, A2 to the depth T of the groove 7, followed by the insertion of the so joined positioning sections A1, A2 into groove 7.

FIGS. 7a, 7b show a process similar to that shown in FIGS. 6a, 6b, 6c, but without a sewing step. The positioning sections A1, A2 joined at the joint line L without a seam are then inserted into groove 7.

While the invention has been illustrated and described as embodied in a grained surface model, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A grained surface model comprising,
a milling model including at least one groove with a groove bottom,
a skin applied to the milling model comprising at least a first cut and a second cut, said first cut and said second cut connected via a joint line so that a first positioning section and a second positioning section are each created between the joint line and a front end of each the first and second cut;
wherein each of the front end of each of the first and second positioning sections are inserted into the groove directed toward the groove bottom and wherein the joint line is tightly sealed.

2. The grained surface model according to claim 1, wherein the joint line is a welded seam or a glued seam.

3. The grained surface model according to claim 2, wherein the two positioning sections are substantially completely welded or glued to each other, so that a joint surface is created.

4. The grained surface model according to claim 1, wherein the joint line is a textile seam.

5. The grained surface model according to claim 4, wherein the two positioning section are connected to each other by a thread-sewn seam.

6. The grained surface model according to claim 5, wherein at least one sealing element is inserted between the first and second positioning sections in direction of the groove bottom so that the positioning sections are sealingly covered.

7. The grained surface model according to claim 6, wherein the sealing element projects out of the groove.

8. The grained surface model according to claim 7, wherein the sealing element is a band and attached to the first and second cut.

9. The grained surface model according to claim 8, wherein the band is sewn together with the first cut and the second cut.

10. The grained surface model according to claim 8, wherein the band is glued to or welded to.

11. The grained surface model according to claim 9, wherein puncture points of a thread are sealingly covered by the band.

12. The grained surface model according to claim 9, wherein the band includes a first bump.

13. The grained surface model according to claim 12, wherein the band has a crease perforation.

14. The grained surface model according to claim 12, wherein the band includes a second bump located opposite the first bump.

15. The grained surface model according to claim 6, wherein the sealing element is an insert which is an element selected from the group consisting of an elastic extrusion profile, a clip-on element, an injection molded part, a heat activated adhesive band and a combination of these elements.

16. The grained surface model according to claim 1, further comprising a reinforcement element at the positioning sections.

17. The grained surface model according to claim 16, wherein the reinforcement element is an element selected from the group consisting of clip-on element, a sewing thread, an adhesive layer and a combination of these elements.

18. The grained surface model according to claim 1, wherein the positioning sections are adjusted to a depth of the groove by an edge trim.

19. The grained surface model according to claim 8, wherein the band is a textile band.

20. The grained surface model according to claim 13, wherein the crease perforation is located in the area of the first bump.
